(19) United States
(12) Patent Application Publication
(10) Pub. No.: US 2014/0348080 A1
(43) Pub. Date: Nov. 27, 2014

(54) UPLINK TRAFFIC PRIORITIZATION AT A USER EQUIPMENT (UE) WITHIN THE SAME BEARER

(71) Applicant: QUALCOMM Incorporated, San Diego, CA (US)

(72) Inventor: Miguel GRIOT, La Jolla, CA (US)

(73) Assignee: QUALCOMM INCORPORATED, San Diego, CA (US)

(21) Appl. No.: 14/283,010

(22) Filed: May 20, 2014

Related U.S. Application Data
(60) Provisional application No. 61/825,954, filed on May 21, 2013.

(51) Int. Cl. H04W 28/02; H04W 72/02

(52) U.S. Cl. CPC H04W 28/0263; H04W 72/02
USPC 370/329

(57) ABSTRACT

Certain aspects of the present disclosure provide methods, apparatus and computer program products for uplink traffic prioritization, by a user equipment (UE), within the same bearer. According to certain aspects, a method for wireless communications by a user equipment (UE) is provided. The method generally includes receiving information regarding prioritization per bearer, receiving an uplink scheduling grant for uplink traffic, assigning the uplink scheduling grant to a bearer based on the information, and prioritizing the uplink traffic within the bearer based on one or more rules.

### CLAIM OF PRIORITY UNDER 35 U.S.C. §119

This application claims benefit of U.S. Provisional Patent Application Ser. No. 61/825,954, filed May 21, 2013, which is herein incorporated by reference in its entirety.

### BACKGROUND

1. Field

Certain aspects of the present disclosure generally relate to wireless communications and, more particularly, to apparatus and techniques for uplink traffic prioritization within the same bearer at a user equipment (UE).

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3^{rd} Generation Partnership Project (3GPP) Long Term Evolution (LTE) systems, and Orthogonal Frequency Division Multiple Access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. The forward communication link and the reverse communication link may be established via a single-input single-output, multiple-input single-output or a multiple-input multiple-output system. To efficiently transmit and receive information, signals are usually encoded into a special format before transmission and decoded by a receiver after reception. Numerous encoding and decoding methods exist, with each presenting advantages and challenges, as well.

A wireless multiple-access communication system can support a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

The 3GPP LTE represents a major advance in cellular technology and it is a next step forward in cellular 3^{rd} generation (3G) services as a natural evolution of Global System for Mobile Communications (GSM) and Universal Mobile Telecommunications System (UMTS). The LTE provides for an uplink speed of up to 75 megabits per second (Mbps) and a downlink speed of up to 300 Mbps, and brings many technical benefits to cellular networks. The LTE is designed to meet carrier needs for high-speed data and media transport as well as high-capacity voice support. The bandwidth may be scalable from 1.25 MHz to 20 MHz. This suits the requirements of different network operators that have different bandwidth allocations, and also allows operators to provide different services based on spectrum. The LTE is also expected to improve spectral efficiency in 3G networks, allowing carriers to provide more data and voice services over a given bandwidth.

Physical layer (PHY) of the LTE standard is a highly efficient means of conveying both data and control information between an enhanced base station (eNodeB) and mobile user equipment (UE). The LTE PHY employs advanced technologies that are new to cellular applications. These include Orthogonal Frequency Division Multiplexing (OFDM) and Multiple Input Multiple Output (MIMO) data transmission. In addition, the LTE PHY uses OFDMA on the downlink and Single Carrier-Frequency Division Multiple Access (SC-FDMA) on the uplink. OFDMA allows data to be directed to or from multiple users on a subcarrier-by-subcarrier basis for a specified number of symbol periods.

### SUMMARY

Certain aspects of the present disclosure generally relate to wireless communication systems and, more specifically, to techniques and apparatus for uplink traffic prioritization, by a user equipment (UE), within the same bearer.

In an aspect of the disclosure, a method for wireless communication by a UE is provided. The method generally includes receiving information regarding prioritization per bearer, receiving an uplink scheduling grant for uplink traffic, assigning the uplink scheduling grant to a bearer based on the information, and prioritizing the uplink traffic within the bearer based on one or more rules.

In an aspect of the disclosure, an apparatus for wireless communication by a UE is provided. The apparatus generally includes means for receiving information regarding prioritization per bearer, means for receiving an uplink scheduling grant for uplink traffic, means for assigning the uplink scheduling grant to a bearer based on the information, and means for prioritizing the uplink traffic within the bearer based on one or more rules.

In an aspect of the disclosure, an apparatus for wireless communication by UE is provided. The apparatus generally includes at least one processor configured to receive information regarding prioritization per bearer, receive an uplink scheduling grant for uplink traffic, assign the uplink scheduling grant to a bearer based on the information, and prioritize the uplink traffic within the bearer based on one or more rules. The apparatus generally also includes a memory coupled with the at least one processor.

In an aspect of the disclosure, a program product for wireless communication by UE is provided. The program product generally includes a computer readable medium having instructions stored thereon for receiving information regarding prioritization per bearer, receiving an uplink scheduling grant for uplink traffic, assigning the uplink scheduling grant to a bearer based on the information, and prioritizing the uplink traffic within the bearer based on one or more rules.

Numerous other aspects are provided including methods, apparatus, systems, computer program products, and processing systems.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system, in accordance with certain aspects of the present disclosure.

FIG. 2 illustrates various components that may be utilized in a wireless device, in accordance with certain aspects of the present disclosure.

FIG. 3 illustrates a block diagram of an eNB in communication with a UE in an access network, in accordance with aspects of the present disclosure.

FIG. 4 illustrates an example transmitter and an example receiver that may be used within a wireless communication system, in accordance with certain aspects of the present disclosure.

FIG. 5 illustrates an example call flow for performing uplink scheduling/prioritization, in accordance with certain aspects of the present disclosure.

FIG. 6 is a flow diagram of example operations 600 for wireless communications, in accordance with certain aspects of the present disclosure.

### DETAILED DESCRIPTION

As will be described in more detail herein, certain aspects of the present disclosure relate to techniques for uplink traffic prioritization, by a user equipment (UE), within the same bearer. Aspects of the present disclosure provide techniques and apparatus for the UE to identify packets as having a certain priority. The priority may be based on configuration by an operator, for example, via open mobile alliance (OMA) device management (DM) protocol. For each bearer, the UE assign uplink grants from the eNB to logical channels/bearers based on the prioritization. The UE may have separate queues for packets of different priorities. The UE may perform prioritization between queues with the bearer.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method, which is practiced using other structure, functionality, or structure and functionality in addition to or other than the various aspects of the disclosure set forth herein. It should be understood that any aspect of the disclosure disclosed herein might be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that use E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

An access terminal (“AT”) may comprise, be implemented as, or known as an access terminal, a subscriber station, a subscriber unit, a mobile station, a remote station, a remote terminal, a user terminal, a user agent, a user device, user equipment (“UE”), a user station, a mobile unit, a wireless unit, a remote unit, a mobile device, a wireless device, a wireless communication device, a remote device, a mobile subscriber station, a mobile terminal, a wireless terminal, a handset, a mobile client, a client, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, a node is a wireless node. Such wireless node may provide, for example, connectivity for or to a network (e.g., a wide area network such as the Internet or a cellular network) via a wired or wireless communication link.

### An Example Wireless Telecommunications System

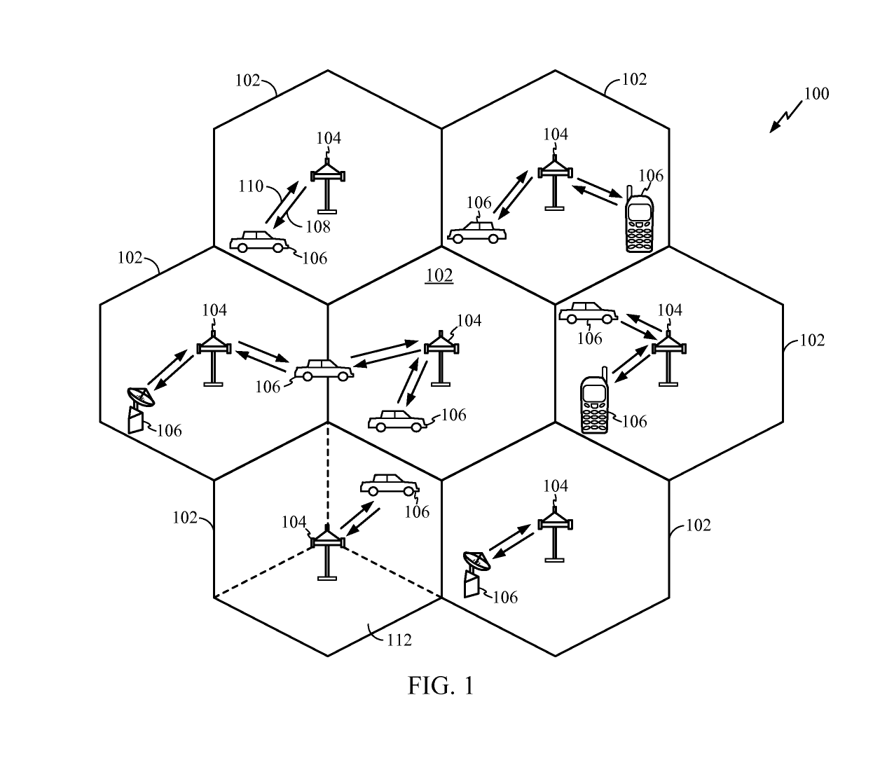

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, evolved Node B (eNB), a base transceiver station, a radio base station, a radio transceiver, a transceiver function, a basic service set (BSS), an extended service set (ESS), or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

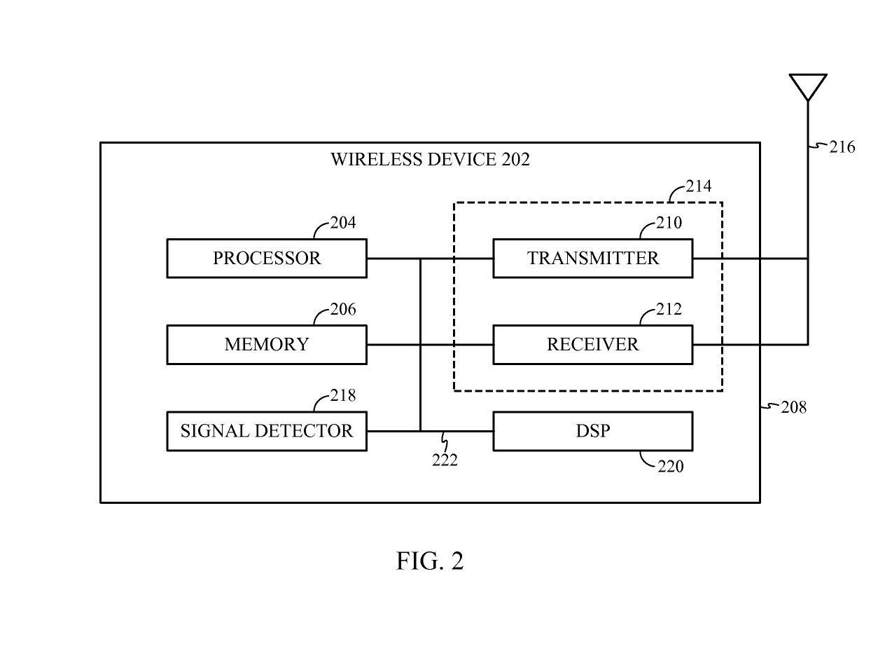

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 that controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density and other signals. The wireless device 202 may also include a digital signal processor (DSP) 220 for use in processing signals.

The various components of the wireless device 202 may be coupled by a bus system 222, which may include a power bus, a control signal bus, and a status signal bus in addition to a data bus.

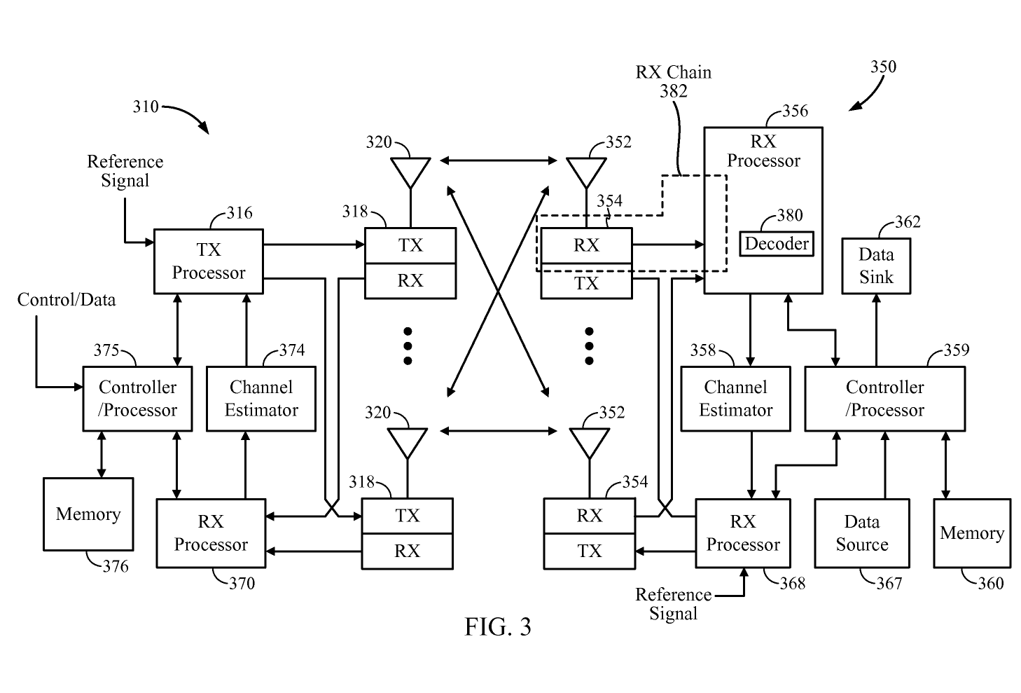

FIG. 3 is a block diagram of an eNB 310 in communication with a UE 350 in an access network. In the DL, upper layer packets from the core network are provided to a controller/processor 375. The controller/processor 375 implements the functionality of the L2 layer. In the DL, the controller/processor 375 provides header compression, ciphering, packet segmentation and reordering, multiplexing between logical and transport channels, and radio resource allocations to the UE 350 based on various priority metrics. The controller/processor 375 is also responsible for HARQ operations, retransmission of lost packets, and signaling to the UE 350.

The TX processor 316 implements various signal processing functions for the L1 layer (i.e., physical layer). The signal processing functions include coding and interleaving to facilitate forward error correction (FEC) at the UE 350 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream is then provided to a different antenna 320 via a separate transmitter 318TX. Each transmitter 318TX modulates an RF carrier with a respective spatial stream for transmission.

At the UE 350, each transmitter/receiver module 354 receives a signal through its respective antenna 352. Each transmitter/receiver module 354 recovers information modulated onto an RF carrier and provides the information to the receiver (RX) processor 356. The RX processor 356 implements various signal processing functions of the L1 layer. The RX processor 356 performs spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal is recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359.

The controller/processor 359 implements the L2 layer. The controller/processor can be associated with a memory 360 that stores program codes and data. The memory 360 may be referred to as a computer-readable medium. In the UL, the control/processor 359 provides demultiplexing between transport and logical channels, packet reassembly, deciphering, header decompression, control signal processing to recover upper layer packets from the core network. The upper layer packets are then provided to a data sink 362, which represents all the protocol layers above the L2 layer. Various control signals may also be provided to the data sink 362 for L3 processing. The controller/processor 359 is also responsible for error detection using an acknowledgement (ACK) and/or negative acknowledgement (NACK) protocol to support HARQ operations.

In the UL, a data source 367 is used to provide upper layer packets to the controller/processor 359. The data source 367 represents all protocol layers above the L2 layer. Similar to the functionality described in connection with the DL transmission by the eNB 310, the controller/processor 359 implements the L2 layer for the user plane and the control plane by providing header compression, ciphering, packet segmentation and reordering, and multiplexing between logical and transport channels based on radio resource allocations by the eNB 310. The controller/processor 359 is also responsible for HARQ operations, retransmission of lost packets, and signaling to the eNB 310.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 are provided to different antenna 352 via separate transmitter/receiver modules 354. Each transmitter/receiver module 354 modulates an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370. The RX processor 370 may implement the L1 layer.

The controller/processor 375 implements the L2 layer. The controller/processor 375 can be associated with a memory 376 that stores program codes and data. The memory 376 may be referred to as a computer-readable medium. In the UL, the control/processor 375 provides demultiplexing between transport and logical channels, packet reassembly, deciphering, header decompression, control signal processing to recover upper layer packets from the UE 350. Upper layer packets from the controller/processor 375 may be provided to the core network. The controller/processor 375 is also responsible for error detection using an ACK and/or NACK protocol to support HARQ operations.

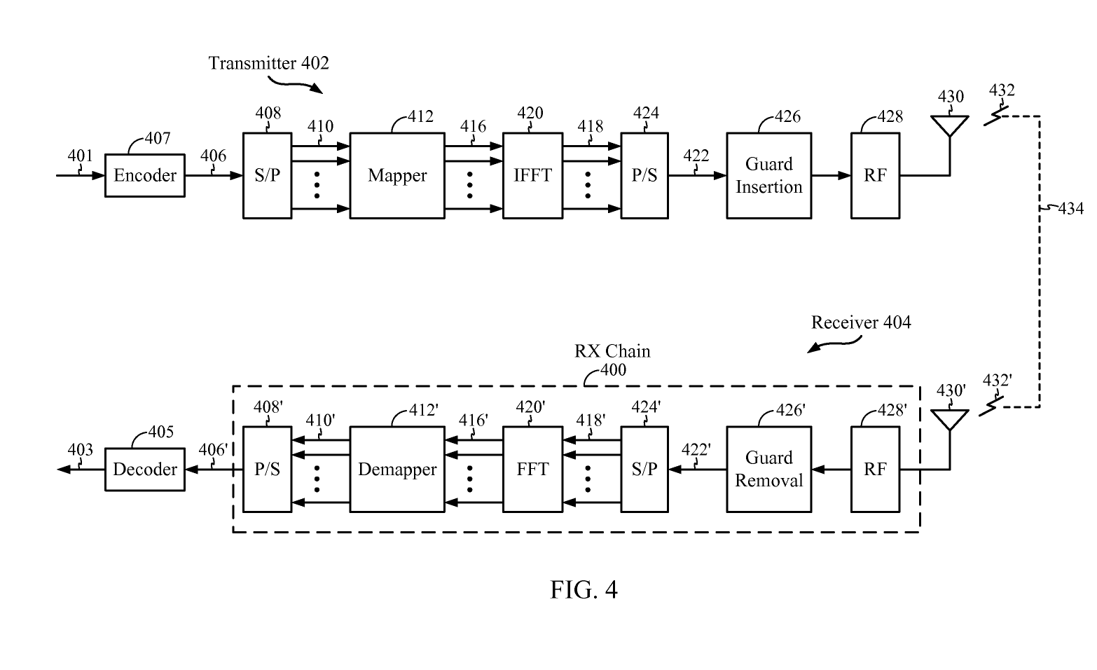

As will be explained in more detail herein, a transmitter, such as the eNB 310, may transmit one or more transport blocks (TBs) to a receiver, which may include one or more components of the UE 350. Receiver chain 382 and decoder 380 may perform aspects of the present disclosure. For example, and as illustrated in FIG. 3, the receiver component of the transmitter/receiver module 354 and RX processor 356 of the receiver chain 382 may identify an error in a received code block (CB) of a TB. In response to the identified error, a decoder 380 of the UE 350 may enter a throttle mode. The throttle mode may determine how one or more subsequent CBs are processed by the UE 350. Components of the receiver chain 382 may be understood in more detail with reference to the receiver chain 400 illustrated in FIG. 4 and described herein.

FIG. 4 illustrates an example of a transmitter 402 that may be used within a wireless communication system 100. Portions of the transmitter 402 may be implemented in a transmitter 210 of a wireless device 202 as illustrated in FIG. 2. The transmitter 402 may be implemented in a base station 104, 310 for transmitting data 406 to a user terminal 106, 350 on a downlink 108. The transmitter 402 may also be implemented in a user terminal 106, 350 for transmitting data 406 to a base station 104, 310 on an uplink 110.

An encoder 407 may alter a signal (e.g., a bitstream) 401 into data 406. Data 406 to be transmitted is provided from the encoder 407 as input to a serial-to-parallel (S/P) converter 408. The S/P converter 408 may split the transmission data into N parallel data streams 410.

The N parallel data streams 410 may then be provided as input to a mapper 412. The mapper 412 may map the N parallel data streams 410 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 412 may output N parallel symbol streams 416, each symbol stream 416 corresponding to one of the N orthogonal subcarriers of the inverse fast Fourier transform (IFFT) 420. These N parallel symbol streams 416 are represented in the frequency domain and may be converted into N parallel time domain sample streams 418 by an IFFT component 420.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to Nₑₚ (the number of guard samples per OFDM symbol)+N (the number of useful samples per OFDM symbol).

The N parallel time domain sample streams 418 may be converted into an OFDM/OFDMA symbol stream 422 by a parallel-to-serial (P/S) converter 424. A guard insertion component 426 may insert a guard interval between successive OFDM/OFDMA symbols in the OFDM/OFDMA symbol stream 422. The output of the guard insertion component 426 may then be upconverted to a desired transmit frequency band by a radio frequency (RF) front end 428. An antenna 430 may then transmit the resulting signal 432.

FIG. 4 also illustrates an example of a receiver 404 that may be used within a wireless device 202 that utilizes OFDM/OFDMA. Portions of the receiver 404 may be implemented in the receiver 212 of a wireless device 202. The receiver 404 may be implemented in a user terminal 106, 350 for receiving data 406 from a base station 104, 310 on a downlink 108. For example, receiver chain 382 illustrated in FIG. 3 may include components illustrated in receiver chain 400. The receiver chain 404 may also be implemented in a base station 104, 310 for receiving data 406 from a user terminal 106, 350 on an uplink 110.

The transmitted signal 432 is shown traveling over a wireless channel 434 from the transmitter 402 to the receiver 404. When a signal 432′ is received by an antenna 430′, the received signal 432′ may be downconverted to a baseband signal by an RF front end 428′. A guard removal component 426′ may then remove the guard interval that was inserted between OFDM/OFDMA symbols by the guard insertion component 426.

The output of the guard removal component 426′ may be provided to an S/P converter 424′. The S/P converter 424′ may divide the OFDM/OFDMA symbol stream 422′ into the N parallel time-domain symbol streams 418′, each of which corresponds to one of the N orthogonal subcarriers. A fast Fourier transform (FFT) component 420′ may convert the N parallel time-domain symbol streams 418′ into the frequency domain and output N parallel frequency-domain symbol streams 416′.

A demapper 412′ may perform the inverse of the symbol mapping operation that was performed by the mapper 412 thereby outputting N parallel data streams 410′. A P/S converter 408′ may combine the N parallel data streams 410′ into a single data stream 406′. Ideally, this data stream 406′ corresponds to the data 406 that was provided as input to the transmitter 402. Following the combination of the N parallel data streams 410′ into a single data stream 406′, the data stream 406′ may be decoded into a decoded data stream 403 by decoder 405 through decoding methods including, for example, turbo decoding. Decoder 405 may correspond to decoder 380 of the RX processor 356 illustrated in FIG. 3.

### Example Uplink Traffic Prioritization at a UE Within the Same Bearer

A user equipment (UE) (e.g., similar to UE 350 illustrated in FIG. 3) can perform prioritization of uplink traffic to a e NodeB (e.g., similar to eNB 310 illustrated in FIG. 3) in order to ensure that the higher priority information (e.g., certain applications) has a higher likelihood of being received (e.g., by a providing a desired quality of service (QoS)), for example, in congestion conditions. According to certain aspects, described in more detail below, the UE may prioritize bearers and also prioritizes queues within a bearer. The UE can determine priority based on uplink grants and can prioritize the data based on rules received from the eNB.

For example, current Long Term Evolution (LTE)/Evolved Packet System (EPS) QoS is defined on a per-bearer basis. Thus, traffic prioritization has a granularity at the bearer level. The majority of mobile data traffic (e.g., Internet or over-the-top services traffic) is currently delivered over default bearers. Multiple operators may have internet traffic going through the default bearer, and it may be desirable to perform prioritization between different applications. It may be desirable to for a UE to perform prioritization within the bearer. It may desirable for the UE to effectively mitigate random access channel (RAN) user plane congestion in order to avoid the negative impact on the perceived service quality for such data traffic.

RAN user plane congestion occurs when the demand for RAN resources exceeds the available RAN capacity to deliver the user data for a period. RAN user plane congestion leads, for example, to packet drops or delays, and may or may not result in degraded end-user experience. RAN user plane congestion includes user plane congestion that occurs over the air interface (e.g., LTE-Uu), in the radio node (e.g., eNB) and/or over the backhaul interface between RAN and core network (CN).

One aspect of RAN congestion mitigation is the capability for the system to prioritize certain traffic (e.g., when performing scheduling). Two types of traffic prioritization may include per-flow prioritization or per-user prioritization. Per-flow prioritization involves traffic from different applications within a bearer. The traffic may be identified, differentiated, and prioritized during RAN user plane congestion in order to provide the appropriate service quality to the different applications. Per-user prioritization involves prioritization of traffic from different users. For example, the traffic from certain users (e.g., gold) may be given a high priority than traffic generated by other users (e.g., normal users). Higher priority traffic may be provided a high service quality.

Conventionally, the focus in SA2 has been downlink traffic. However, some applications generate considerable traffic in the uplink direction, for example, peer-to-peer applications, gaming, video conferencing, etc. For UL scheduling, the eNB provides grants per-UE—not per-flow or per-bearer. Therefore, flows that generate high traffic may potentially starve other flows.

Generally, whenever a specific traffic flow is being prioritized, or de-prioritized, in the downlink direction the traffic flow should receive the same priority in the uplink direction. The same may apply for per-user prioritization (i.e., when a specific user traffic is prioritized in the downlink direction, the user traffic should receive the same priority in the uplink direction).

Therefore, techniques for both uplink traffic prioritization and downlink traffic prioritization may be desirable. Ideally, a unified solution that applies to both UL and DL may also be desirable. If different solutions are used for UL and for DL for certain use cases, may work well for applications requiring both uplink and downlink flows. For instance, solutions should allow that a same data flow receives equal priority (e.g. high/low) in both uplink and downlink, particularly for the case when both directions are congested.

The UE may have an uplink rate control function that manages the sharing of uplink resources between radio bearers. The uplink rate control function may be controlled using radio resource control (RRC) signaling by assigning a priority to each bearer. Optionally, a prioritized bit rate (PBR) may be assigned to each bearer. The PBR may be signaled by the eNB. The PBR values signaled by the eNB may be unrelated to PBR values signaled to the eNB (e.g., via S1). A one-to-one mapping may exist between a radio bearer and a logical channel. The eNB may provide this mapping and, along with the priority and PBR of each logical channel/bearer, the eNB may also provide a bucket size duration (BSD) and assign a logical channel group (LCG) (e.g., using only four values).

The uplink rate control function may ensure that the UE serves its radio bearer(s) by first serving all the radio bearer(s) in decreasing priority order (i.e., highest priority to lowest priority) up to their PBR (if not zero) and then the UE services its radio bearers in decreasing priority order for the remaining resources assigned by the grant. In the case the PBRs are all set to zero, the first step may be skipped and the radio bearer(s) are served in strict priority order. In this case, the UE may maximize the transmission of higher priority data. If more than one radio bearer has the same priority, the UE may serve the radio bearers equally.

The UE may provide the eNB with buffer status reports (BSR) (e.g., per-LCG). The BSRs may be designed to minimize signaling overhead. It may be undesirable to extend the BSRs to provide additional information, such as, for example, which type of flow is present at the UE buffers.

The eNB may provide the uplink scheduling grants based on the BSRs provided by the UE. The eNB may provide the uplink scheduling grants to the UE—not to a particular logical channel/bearer. The UE may use the grants based on the priority/PBR of each logical channel (e.g., per TS 36.321 specification). The UE may maintain a variable, Bj, for each logical channel j. Bj can be incremented by the product PBR×TTI duration for each TTI, where PBR is the PBR of logical channel j. However, the value of Bj may not exceed the bucket size, where the bucket size equals PBR×BSD.

The UE may allocate resources to the logical channels by first allocating resources to all logical channels with Bj>0 in a decreasing priority order. If the PBR of a radio bearer is set to “infinity”, the UE may allocate resources for all the data available for transmission on the radio bearer before meeting the PBR of the lower priority radio bearer(s). Then, the UE may decrement Bj by the total size of medium access control (MAC) service data units (SDUs) served to logical channel j in the first step.

For uplink scheduling, the eNB may be a-priori unaware of the type of content that is present in the UE buffer. This may be different from downlink scheduling, where the eNB can prioritize packets based on either bearer classification or packet markings received from the packet gateway (PGW).

For uplink scheduling, while it may be desirable for the eNB to perform per-user prioritization because the eNB provides UL scheduling grants to each UE, it may be desirable for the UE to perform per-flow prioritization based on the scheduling grants provided by the eNB.

Accordingly, what is needed are techniques for a UE to perform uplink prioritization within a bearer/logical channel.

Techniques and apparatus are provided herein for uplink prioritization within a bearer. A UE may identify packets as having a certain priority. The priority may be based on configuration by an operator, for example, via open mobile alliance (OMA) device management (DM) protocol. Based on the prioritization, the UE can assign uplink grants from the eNB to logical channels/bearers (i.e., perform uplink scheduling). Within each bearer, the UE may have separate queues for packets identified with different priorities. The UE may perform prioritization between the queues within the bearer.

According to certain aspects, per-flow prioritization within a bearer may be performed by the UE in the uplink direction. In aspects, the network may provide rules to the UE on how to perform the prioritization. In order to be consistent with the eNB uplink scheduling grant mechanism, the UE may first perform logical channel prioritization (e.g., as configured via RRC). Then, once the UE allocates resources to a certain logical channel according to the logical channel prioritization, the UE may perform traffic flow prioritization within the logical channel/bearer. However, although per-flow prioritization can be performed within the UE, this does not cover per-user prioritization as in the downlink case, where the eNB may be aware of both type of users and type of flows.

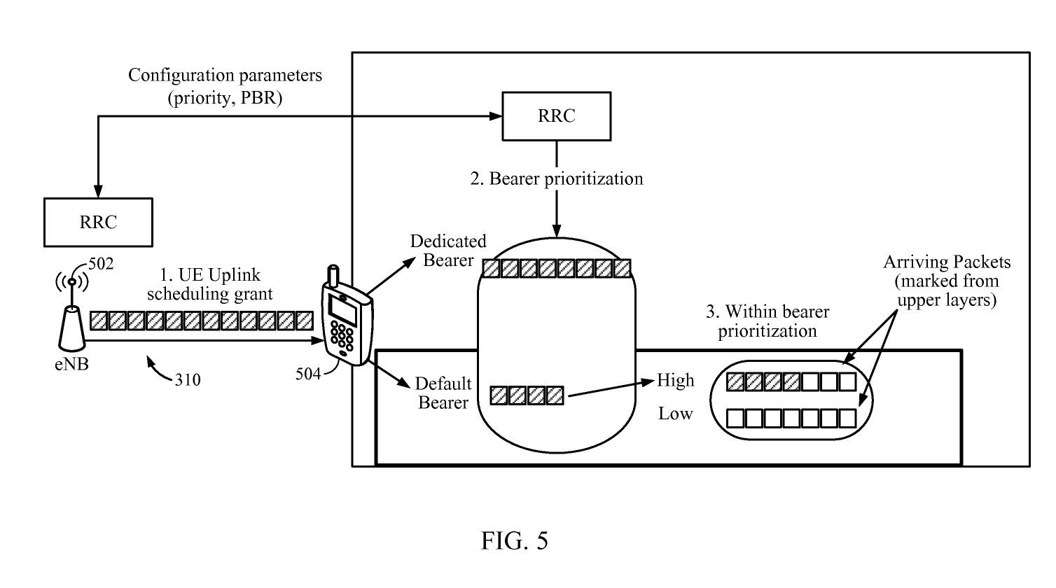

One solution for uplink prioritization and traffic limitation may be based on whether the data traffic is attended or unattended and may involve a three-step approach for uplink prioritization. FIG. 5 illustrates an example call flow for performing uplink scheduling/prioritization, in accordance with certain aspects of the present disclosure. As shown in FIG. 5, at 1, per-user prioritization may be performed by the eNB 502 through normal uplink scheduling grants 506 to the UE 504. As shown in FIG. 5, at 2, per-bearer prioritization may be configured by the eNB 502 via RRC signaling and executed by the UE 504. At 3, the UE 504 may perform within-bearer uplink traffic flow prioritization based on certain rules/configuration from the operator/network.

According to certain aspects, for within-bearer uplink prioritization, the UE 504 may performs uplink packet scheduling by performing logical channel (i.e., bearer) prioritization based on the configuration parameters received via RRC from the eNB 502. In aspects, each logical channel may have a number of queues (e.g., 2 or 3 queues) with different priorities. In aspects, once a logical channel receives a certain amount of data to be transmitted, prioritization between the queues may be performed to select which packets to transmit. In aspects, in order not to avoid increased complexity in the UE 504, the number of within-bearer priority values may be two values (e.g., High, Low) or three values (e.g., High, Normal, Low).

According to certain aspects, the operator/network may configure how the UE (e.g., UE 504) decides the priority of each traffic flow. In aspects, the UE may be configured via non-access stratum (NAS). A traffic flow template (TFT) may be extended to define further attributes. In aspects, the home operator may decide which traffic is important or less important for the user. This may be passed from home public land mobile network (HPLMN) to visited PLMN (VPLMN), for example, by extending the subscription information. Since there may be several rules and configuration options, signaling between home subscriber server (HSS) and mobile management entity (MME) may be significantly increased,

Alternatively, the UE may be configured via open mobile alliance (OMA) device management (DM) protocol. This approach may have the benefits of not frequently changing, minimizing network signaling, and allowing for easier extensions in the future (e.g., as rules for traffic prioritization may change). Additionally, rules provided by home operators may work even when the UE is roaming in a VPLMN not supporting any user-plane congestion (UPCON) management enhancement.

According to certain aspects, prioritization configuration parameters may include Application ID: OS→OS_AppID (e.g., similar to what was defined in TS 24.312). In aspects, other traffic characteristics may be included. Each entry may consist of any combination of the above (e.g., [AppID, . . . ]) and a priority value (e.g., high/normal/low).

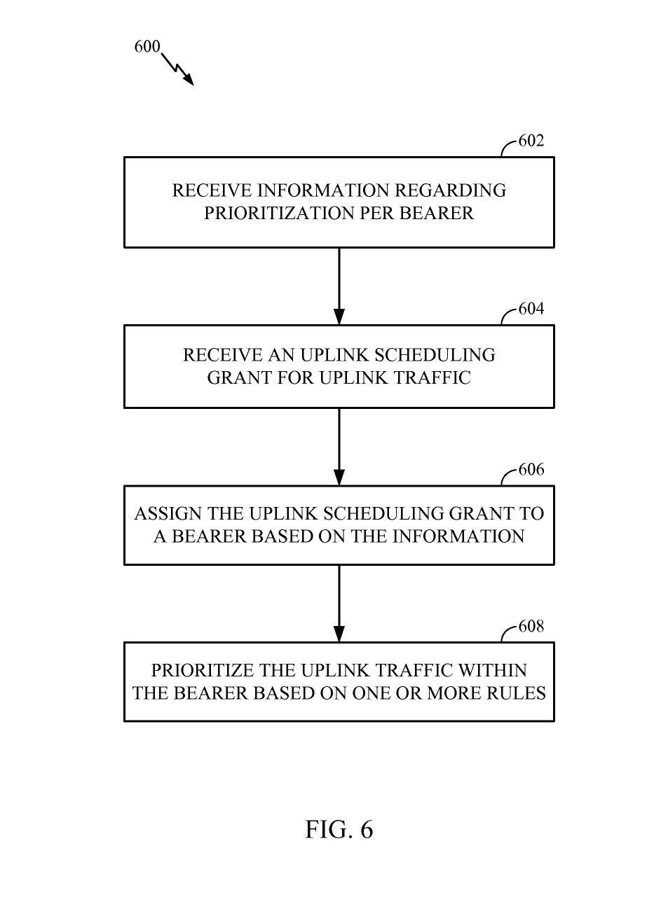

FIG. 6 is a flow diagram of example operations 600 for wireless communications, in accordance with certain aspects of the present disclosure. The operations 600 may be performed, for example, by a UE (e.g., UE 350 of FIG. 3 implemented at UE 106 of FIG. 1).

The operations 600 may begin, at 602, by receiving information regarding prioritization per bearer. For example, the information regarding prioritization per bearer may be received via RRC.

At 604, the UE may receive an uplink scheduling grant for uplink traffic.

At 606, the UE may assign the uplink scheduling grant to a bearer based on the information.

At 608, the UE may prioritize the uplink traffic within the bearer based on one or more rules. For example, the UE may receive packets marked by upper layers to indicate the priority of the packets (e.g., low, medium, or high) and assign the packets into different queues (e.g., 2 or 3 queues) based on the markings. In aspects, some of the rules may be based on application ID.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

As used herein, a phrase referring to “at least one of” a list of items refers to any combination of those items, including single members. As an example, “at least one of: a, b, or c” is intended to cover: a, b, c, a-b, a-c, b-c, and a-b-c.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communications by a user equipment (UE), comprising:
receiving information regarding prioritization per bearer;
receiving an uplink scheduling grant for uplink traffic;
assigning the uplink scheduling grant to a bearer based on the information; and
prioritizing the uplink traffic within the bearer based on one or more rules.

2. The method of claim 1, wherein at least one of the one or more rules is based on application ID.

3. The method of claim 1, wherein the information regarding prioritization per bearer is received via radio resource control (RRC).

4. The method of claim 1, wherein prioritizing the uplink traffic within the bearer comprises:
receiving packets marked by upper layers to indicate a priority of each packet; and
assigning the packets into different queues within the bearer based on the markings.

5. The method of claim 4, wherein the markings comprise one of low priority, medium priority, or high priority, and wherein the packets are assigned to three different queues within the bearer based on the markings.

6. The method of claim 4, wherein the markings comprise one of low priority or high priority, and wherein the packets are assigned to two different queues within the bearer based on the markings.

7. An apparatus for wireless communications by a user equipment (UE), comprising:
means for receiving information regarding prioritization per bearer;
means for receiving an uplink scheduling grant for uplink traffic;
means for assigning the uplink scheduling grant to a bearer based on the information; and
means for prioritizing the uplink traffic within the bearer based on one or more rules.

8. The apparatus of claim 7, wherein at least one of the one or more rules is based on application ID.

9. The apparatus of claim 7, wherein the information regarding prioritization per bearer is received via radio resource control (RRC).

10. The apparatus of claim 7, wherein the means for prioritizing the uplink traffic within the bearer comprises:
means for receiving packets marked by upper layers to indicate a priority of each packet; and
means for assigning the packets into different queues within the bearer based on the markings.

11. The apparatus of claim 10, wherein the markings comprise one of low priority, medium priority, or high priority, and wherein the packets are assigned to three different queues within the bearer based on the markings.

12. The apparatus of claim 10, wherein the markings comprise one of low priority or high priority, and wherein the packets are assigned to two different queues within the bearer based on the markings.

13. An apparatus for wireless communications by a user equipment (UE), comprising:
at least one processor configured to:
receive information regarding prioritization per bearer;
receive an uplink scheduling grant for uplink traffic;
assign the uplink scheduling grant to a bearer based on the information; and
prioritize the uplink traffic within the bearer based on one or more rules; and
a memory coupled with the at least one processor.

14. The apparatus of claim 13, wherein at least one of the one or more rules is based on application ID.

15. The apparatus of claim 1, wherein the information regarding prioritization per bearer is received via radio resource control (RRC).

16. The apparatus of claim 13, wherein prioritizing the uplink traffic within the bearer comprises:
receiving packets marked by upper layers to indicate a priority of each packet; and
assigning the packets into different queues within the bearer based on the markings.

17. The apparatus of claim 16, wherein the markings comprise one of low priority, medium priority, or high priority, and wherein the packets are assigned to three different queues within the bearer based on the markings.

18. The apparatus of claim 16, wherein the markings comprise one of low priority or high priority, and wherein the packets are assigned to two different queues within the bearer based on the markings.

19. A program product for wireless communications by a user equipment (UE), comprising a computer readable medium having instructions stored thereon for:
receiving information regarding prioritization per bearer;
receiving an uplink scheduling grant for uplink traffic;
assigning the uplink scheduling grant to a bearer based on the information; and
prioritizing the uplink traffic within the bearer based on one or more rules.

20. The program product of claim 19, wherein at least one of the one or more rules is based on application ID.

21. The program product of claim 19, wherein the information regarding prioritization per bearer is received via radio resource control (RRC).

22. The program product of claim 19, wherein the instructions for prioritizing the uplink traffic within the bearer comprise:
instructions for receiving packets marked by upper layers to indicate a priority of each packet; and
instructions for assigning the packets into different queues within the bearer based on the markings.

23. The program product of claim 22, wherein the markings comprise one of low priority, medium priority, or high priority, and wherein the packets are assigned to three different queues within the bearer based on the markings.

24. The program product of claim 22, wherein the markings comprise one of low priority or high priority, and wherein the packets are assigned to two different queues within the bearer based on the markings.
